(19) United States
(12) Patent Application Publication
(10) Pub. No.: US 2019/0215139 A1
(43) Pub. Date: Jul. 11, 2019

(54) Digital CW Cancellation for High QAM For Point-to-Point FDD Systems

(71) Applicant: Maxlinear, Inc., Carlsbad, CA (US)

(72) Inventors: Kobi Sturkovich, Netanya (IL); Ronen Shaked, Kfar-Saba (IL); Eitan Tsur, Rishon Lezion (IL)

(21) Appl. No.: 15/864,985

(22) Filed: Jan. 8, 2018

(51) Int. Cl. H04L 5/14; H04L 12/26

(52) U.S. Cl. CPC H04L 5/1461; H04B 1/0007; H04L 43/50

(57) ABSTRACT

Systems and methods are provided for digital interference cancellation during continuous wave (CW) tests for high quadrature amplitude modulation (QAM) for point-to-point frequency-division duplexing (FDD) systems. During reception of signals, test signals that are configured for assessing performance in accordance with a particular criterion, in a device or a system handling the reception, may be injected. During processing of the received signals, and in response to a determination that the test signals and one or more other signals different than the received RF signals, cause interference to the received RF signals, and where the interference is unrelated to the assessing based on the criteria, one or more cancellation adjustments may be applied, during processing of the RF signals, for mitigating effects of the interference.

### TECHNICAL FIELD

Aspects of the present disclosure relate to communications solutions. More specifically, certain implementations of the present disclosure relate to methods and systems for a digital interference cancellation during continuous wave (CW) tests for high quadrature amplitude modulation (QAM) for point-to-point frequency-division duplexing (FDD) systems.

### BACKGROUND

Various issues may exist with conventional approaches for interference, such as in microwave communications. In this regard, conventional systems and methods, if any existed, for achieving high-modulations and comply with requirements set forth for microwave communications, may be costly, inefficient, and/or ineffective. Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for a digital interference cancellation during continuous wave (CW) tests for high quadrature amplitude modulation (QAM) for point-to-point frequency-division duplexing (FDD) systems, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an example communication setup.

FIG. 2 illustrates an example use scenario where a continuous wave (CW) and at least one unwanted signal may introduce interference onto a wanted signal.

FIG. 3 illustrates an example high-level chipset implementation in a system that may be configured for supporting digital interference cancellation during continuous wave (CW) tests, in accordance with the present disclosure.

FIG. 4 illustrates an example receiver configured for supporting digital interference cancellation during continuous wave (CW) tests, in accordance with the present disclosure.

FIG. 5 illustrates a flowchart of an example process for digital interference cancellation during continuous wave (CW) tests, in accordance with the present disclosure.

### DETAILED DESCRIPTION OF THE INVENTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

An example method in accordance with the present disclosure may comprise, receiving radio frequency (RF) signals in a communication device, injecting test signals configured for assessing performance of the communication device in accordance with at least one criterion; processing the received RF signals determining when the test signals and one or more other signals different than the received RF signals cause interference to the received RF signals, with the interference being unrelated to the assessing based on the at least one criterion; and applying one or more cancellation adjustments, during processing of the RF signals, for mitigating effects of the interference.

In an example implementation, wherein the one or more other signals may comprise blockers and/or transmit leakage based signals.

In an example implementation, wherein the test signals may comprise continuous wave (CW) signals.

In an example implementation, wherein the interference may comprise intermodulation (IM) related interference or distortion.

In an example implementation, wherein applying the one or more cancellation adjustments comprises: applying analog-to-digital conversion to the received RF signals; determining linear compensation based on the received RF signals, the test signals, and one or more other signals; and digitally applying the linear compensation to the received RF signals.

In an example implementation, may comprise adaptively configuring the test signals based on characteristics of the received RF signals.

In an example implementation, the adaptive configuring may comprise setting power of the test signals to meet a particular power ratio criterion relative to the received RF signals.

In an example implementation, the particular power ratio criterion may comprise being at least 30 dBc above the received RF signals.

In an example implementation, the at least one criterion is based on requirements set forth by a particular organization.

In an example implementation, the organization may be the European Telecommunications Standards Institute (ETSI), and the requirements comprise: the test signals may comprise continuous wave (CW) signals; the continuous wave (CW) signals being adaptively configured based on the received RF signals; and the communication device exhibiting, in response to injecting the continuous wave (CW) signals, a sensitivity level meeting one or more particular thresholds.

An example system in accordance with the present disclosure may comprise, a receiver circuit and a cancellation circuit, with the receiver circuit being operable to receive radio frequency (RF) signals; inject test signals configured for assessing performance of the communication device in accordance with at least one criterion; and process the received RF signals; and the cancellation circuit being operable to determine when the test signals and one or more other signals different than the received RF signals cause interference to the received RF signals, with the interference being unrelated to the assessing based on the at least one criterion; and apply one or more cancellation adjustments, during processing of the RF signals, for mitigating effects of the interference.

In an example implementation, the one or more other signals may comprise blockers and/or transmit leakage based signals.

In an example implementation, the test signals may comprise continuous wave (CW) signals.

In an example implementation, the interference may comprise intermodulation (IM) related interference or distortion.

In an example implementation, the cancellation circuit may be operable to, when applying the one or more cancellation adjustments: apply analog-to-digital conversion to the received RF signals; determine linear compensation based on the received RF signals, the test signals, and one or more other signals; and digitally apply the linear compensation to the received RF signals.

In an example implementation, one or both of the receiver circuit and the cancellation circuit may be operable to adaptively configure the test signals based on characteristics of the received RF signals.

In an example implementation, the adaptive configuring may comprise setting power of the test signals to meet a particular power ratio criterion relative to the received RF signals.

In an example implementation, the particular power ratio criterion may comprise being at least 30 dBc above the received RF signals.

In an example implementation, wherein the at least one criterion is based on requirements set forth by a particular organization.

In an example implementation, the organization may be the European Telecommunications Standards Institute (ETSI), and the requirements comprise: the test signals may comprise continuous wave (CW) signals; the continuous wave (CW) signals being adaptively configured based on the received RF signals; and the communication device exhibiting, in response to injecting the continuous wave (CW) signals, a sensitivity level meeting one or more particular thresholds.

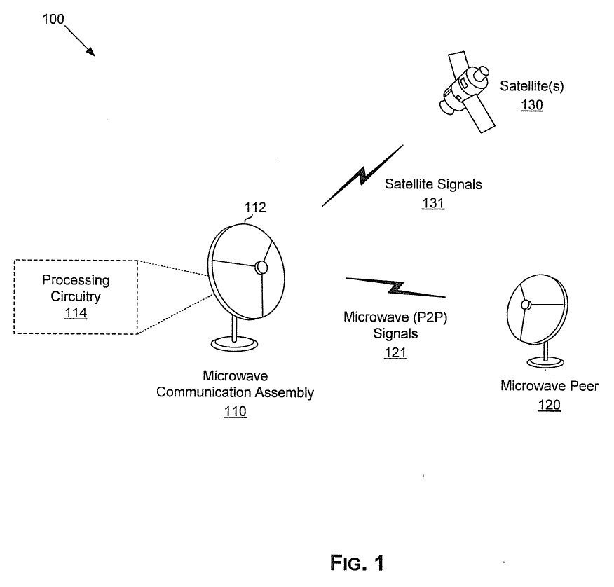

FIG. 1 illustrates an example communication setup. Shown in FIG. 1 is a communication setup 100.

The communication setup 100 may comprise a plurality of communication elements (as well as communication related resources, such as storage resources, processing resources, routing resources, etc.) which may communicate with one another using direct and/or indirect links or connections (wireless and/or wired), in accordance with particular bands, interfaces, and/or protocols/standards.

In some instances, the communication setup 100 may be configured to support microwave communications, whereby microwave signals are used in communication (e.g., to transmit data) between communication elements. Microwave signals may comprise radio signals having wavelengths ranging between 1.0 and 30.0 cm, thus occupying part of the radio spectrum comprising frequencies in the range of ˜1.0 to 30 gigahertz (GHz). Microwave communications may be particularly well suited for use in point-to-point (P2P) communications, since the relatively small wavelength of microwave signals may allow for use of conveniently-sized antennas, which may be particularly suited for transmission and/or reception of narrow beams.

Thus, transmitted microwave signals may be pointed directly at receiving antenna(s). As a result, the same frequencies may be used by microwave communication equipment that may be near one another, without the communication equipment interfering with each other. Another advantage of microwave communication is that the high frequencies of microwaves result in microwave bands having very large information-carrying capacities.

Nonetheless, there may be some limitations of microwave communications. For example, the very reasons that may make microwave particularly suited for point-to-point direct communication limits microwave communications to line of sight (LOS) communications. In this regard, the relatively small wavelengths (and high frequencies) of microwave signals makes them unable to pass through various physical obstacles, such as mountains, as lower frequency radio waves can.

An example use scenario of typical microwave communication is shown in FIG. 1, in which the communication setup 100 may comprise a microwave communication assembly 110 and a microwave link peer 120. In this regard, the microwave communication assembly 110 may be used to facilitate point-to-point (P2P) communications with the microwave peer 120, whereby the two elements may communicate using microwave P2P signals 121.

In addition to use in terrestrial (on-Earth) P2P communications, microwave communications may also be used in conjunction with satellite communications, and in deep space radio communications. Other uses of microwaves include radars, radio navigation, sensor systems, and radio astronomy. For example, as shown in the implementation depicted in FIG. 1, the communication setup 100 may also comprise one or more satellites 130. In this regard, the microwave communication assembly 110 may be configured to communicate (e.g., receive) signals 131 communicated by the satellite(s) 130. For example, each satellite 130 may be utilized to communicate signals 131 (which typically comprise only downlink communication signals; but the disclosure is not so limited, and in some instances the signals 131 may also comprise uplink signals). The satellite signals 131 may be configured as microwave signals.

The microwave communication assembly 110 (and similarly the microwave peer 120) may be configured for supporting microwave communications (e.g., being installed at particular location to allow transmission and/or reception of microwave signals). For example, the microwave communication assembly 110 may comprise an antenna 112 and a processing circuitry 114. The antenna 112 may be used in receiving and/or transmitting microwave signals. For example, the antenna 112 may be a parabolic antenna (e.g., a parabolic reflector), which may be used for capturing microwave signals, such as by reflecting them into a particular point (e.g., focal point of the parabolic reflector); and/or may be used for transmitting microwave signals, such as by deflecting signals emitted from the focal point of the parabolic reflector.

The processing circuitry 114 may be operable to handle and/or process signals transmitted and/or received by the microwave communication assembly 110. The processing circuitry 114 may be incorporated into, for example, a housing that may be mounted on a boom at or near the focal point of the parabolic antenna (reflector) 112. In addition, or alternatively, the processing circuitry 114 may be coupled to the antenna 112.

On the receive-side, the processing circuitry 114 may be configured to, for example, process captured microwave signals, so as to recover data carried therein, and to generate an output corresponding to the recovered data, which may be suitable for transmission to other devices that may handle use and/or distribution of the data. The distribution of the data may be made over one or more particular types of connections or links, and/or in accordance with one or more protocols.

On the transmit-side, the processing circuitry 114 may be configured to, for example, receive data intended for transmission, and may process the data (or any signals carrying the data) to enable generation of corresponding microwave signals (carrying the data), with the generated microwave signals being particularly configured or adapted for transmission via the antenna 112, and/or for transmission to particular intended recipient (e.g., the microwave peer 120). Example processing functions that may be performed by the processing circuitry 114 may comprise amplification, filtering, down-conversion (e.g., RF signals to IF signals), up-conversions (e.g., IF to RF), analog-to-digital conversion and/or digital-to-analog conversion, encoding and/or decoding, encryption and/or decryption, modulation and/or demodulation, etc.

Certain challenges and issues may arise in conjunction with use of microwave communications. For example, the growth in use of microwave communications and related microwave point-to-point backhaul is causing an increase in capacity demand. This capacity demand, however, is exponential and microwave equipment may be struggling to catch up. Thus, many systems that are being deployed are incorporating use of optimization techniques, such as high modulation schemes (e.g., 4096QAM) and/or advanced link utilization methods (e.g., multiple-input and multiple-output (MIMO)), to meet this increase in capacity demand.

Use of such optimization techniques, however, poses its own challenges. For example, in many instances systems or solutions incorporating use of such optimization techniques may have to meet or comply with requirements set forth by pertinent governing bodies (e.g., governmental agencies, standardization organizations, etc.). One of the challenges of achieving high-modulations, for example, is the capability to pass the ETSI (European Telecommunications Standards Institute) CW (continuous wave) test. In this regard, the ETSI CW test is defined as: 1) the system needs to be configured to a particular sensitivity level (e.g., bit error rate (BER) of 1E-6); 2) the CW must be at particular level relative to (e.g., at 30 dBc above) wanted signal needs to be injected into the system; and 3) the system should not be affected beyond a certain threshold (e.g., BER should not take hit higher than (BER=1 E-5)).

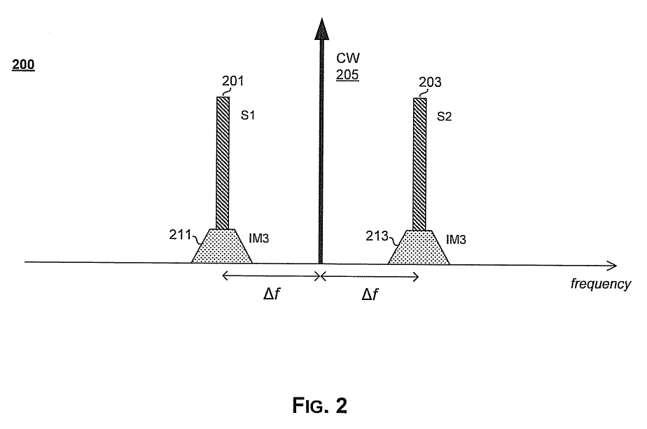

Passing such test may be relatively easy when lower modulation schemes (e.g., 256QAM) are used, but the test may provide high barrier for higher modulation (e.g., 4096QAM) based systems. For example, because the ETSI CW test requires injecting CW at 30 dB higher that the wanted signals, and with sensitivity levels in a system with 4096QAM modulation possibly reaching up to ˜−50 dBm, the CW may reach −20 dBm. Injecting such CW signals (−20 dBm CW), however, in systems operating at such a sensitivity level may pose a huge challenge—e.g., as the RF dynamic range may not handle signals and CW ultra-high signals corresponding to such sensitivity level. Further, while it may be possible (though very challenging) to design a system supporting such a high dynamic range, it may be almost impossible having the system also handle effects of intermodulation of the injected CW and an additional (unwanted) signals on wanted signals. Such use scenario is illustrated in FIG. 2.

FIG. 2 illustrates an example use scenario where a continuous wave (CW) and at least one unwanted signal may introduce interference onto a wanted signal. Shown in FIG. 2 is a frequency chart 200, corresponding to an example use scenario.

In frequency chart 200, signal S1 201 corresponds to a wanted signal (e.g., for reception in a system), and signal S2 203 is an unwanted signal (e.g., interferer, such as transmit (TX) leakage or second channel in dual channel configuration). Also shown is CW signal 205 which is a test interferer which may be injected to ensure compliance with a particular test (e.g., the ETSI CW test). In this regard, as shown in FIG. 2, the CW signal 205 may be higher (e.g., 30 dBs, thus reaching −20 dBm in systems with sensitivity levels reaching to ˜−50 dBm) than the wanted signal S1 201, and signal S2 203 may be up between −50 dBm to −30 dBm.

Further, intermodulation distortion may occur in the system, also affecting reception of the wanted signal S1 201. For example, as shown in FIG. 2, 3rd order intermodulation distortion (IM3) may occur to each of signals S1 201 and S2 203 (e.g., IM3 211 and IM3 212 as shown in FIG. 2). In this regard, IM3 211 at S1 may be: a₃*S₂²(t)*S₁(t); whereas IM3 213 at S2 may be: a₃*S₁²(t)*S₂(t).

The system may need to be configured to account for the effect of all these interferers and/or distortions. For example, the third-order intercept point (IIP3) of the receiver may need to be very high to protect from these intermodulation products, which complicates receiver design and significantly adds to its cost.

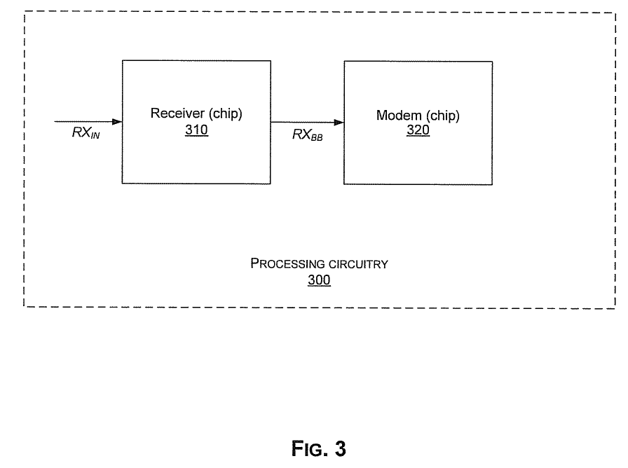

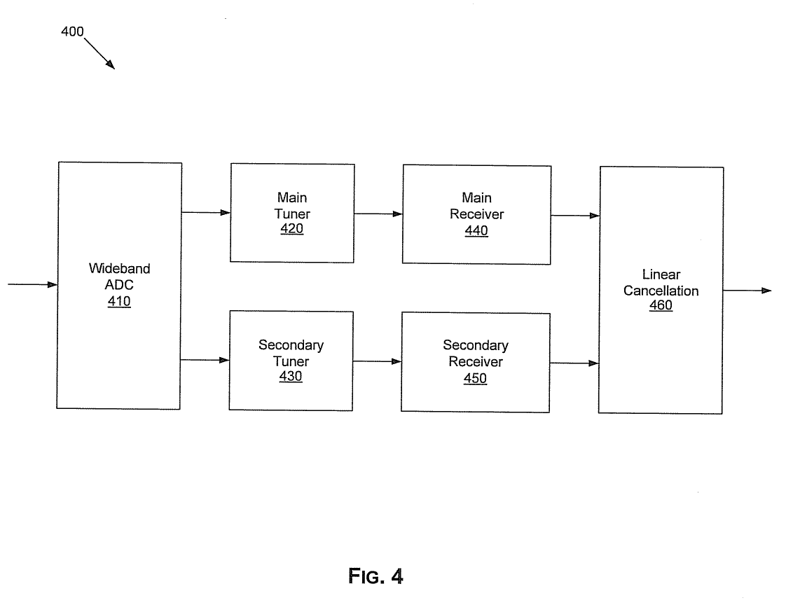

Accordingly, in accordance with the present disclosure, such issues (e.g., distortion or interference) may be addressed in an optimized and adaptive manner, and without requiring complex and costly modification to the design and implementation of in receiving systems. In particular, in various implementations in accordance with the present disclosure, intermodulation may be cancelled digitally, such as using linear cancellation (e.g., similar to mechanisms used in XPIC (cross-polarization interference cancellation) systems). An example implementation is described in more detail below with respect to FIGS. 3 and 4.

FIG. 3 illustrates an example high-level chipset implementation in a system that may be configured for supporting digital cancellation in conjunction with handling of continuous wave (CW) injections, in accordance with the present disclosure. Shown in FIG. 3 is circuitry 300.

The circuitry 300 may be incorporated within a system for use in handling communication of signals (e.g., microwave signals). For example, the circuitry 300 may be substantially similar to the processing circuitry 114 of the assembly 110 in FIG. 1. The circuitry 300 may be operable to handle reception of microwave signals, and to enable mitigating effects of interference and/or distortion (e.g., intermodulation interference or distortion, such as IM3 base interference or distortion), particularly to ensure compliance to certain requirements (e.g., the ETSI CW test). As shown in the example implementation depicted in FIG. 3, the circuitry 300 may comprise a receiver 310 and a modem 320. In this regard, each of the receiver 310 and the modem 320 may be implemented as circuitry chipset or a system-on-a-chip (SoC).

The receiver 310 may comprise suitable circuitry for performing functions associated with reception of signals (e.g., amplification, mixing, filtering, analog-to-digital conversion, etc.). The modem 320 may comprise suitable circuitry for handling modulation and/or demodulation functions. In this regard, the modem 320 may be operable to handle high modulation schemes (e.g., 4096QAM).

The circuitry 300 (and/or the system incorporating the circuitry 300) may be configured for supporting digital cancellation in conjunction with handling of continuous wave (CW) injections. In this regard, as noted with respect to FIG. 2, injection of CW signals (e.g., in compliance with particular testing conditions, as set forth in the ETSI CW test, for instance) may introduce interference that may be hard to handle, particularly in the presence of other (unwanted) signals and/or intermodulation distortion (e.g., IM3). Thus, the circuitry 300 may be configured to apply digital cancellation, particularly in such conditions.

For example, assuming X³ response, the linear cancellation may be determined based on the equations:

(P₁+P₂+CW)+A*(P₁+P₂+CW)³=P₁+ . . . +3*A*CW²P₂+A*P₁³. . . =P₁+ . . . +(3*A*cos²(w_{c}t)*B·cos(w₂t))+ . . . =P₁+ . . . +3*A*B*cos((2w_{c}−w₂)t)+ . . . =Baseband (BB) equivalent=P₁(w)+K*P₂(−w+dw)

where K is equivalent to linear leakage, −w is spectral inversion, and dw is frequency offset.

This signal (i.e., the baseband (BB) equivalent) may be applied digitally (e.g., within the modem 320) to cancel linear interferer(s) without disrupting or affecting processing of the wanted signals.

FIG. 4 illustrates an example receiver configured for supporting digital interference cancellation during continuous wave (CW) tests, in accordance with the present disclosure. Shown in FIG. 4 is a circuitry 400 which may be operable to apply digital cancellation, such as to ensure handling injecting continuous wave (CW).

In particular, the circuitry 400 may be configured for cancelling interference when handling CW injection, such as due to unwanted signals and/or intermodulation distortion. The circuitry 400 may correspond to, for example, the modem 320 of FIG. 3. In the example implementation shown in FIG. 4, the circuitry 400 comprises a wideband analog-to-digital converter (ADC) 410, a main tuner 420, a secondary tuner 430, a main receiver 440, a secondary receiver 450, and a linear cancellation circuit 460.

The analog-to-digital converter (ADC) 410 may be operable to apply wideband analog-to-digital conversions, using a sampling rate of 1.4 GHz for example. The main tuner (e.g., a digital wideband tuner) 420 and the main receiver (e.g., digital wideband receiver) 440 may be configured for receiving and processing signals at a particular frequency. In this regard, the main tuner 420 and the main receiver 420 may capture and process the wanted signal (e.g., signal S1 in FIG. 2). The secondary tuner (e.g., a digital wideband tuner) 430 and the secondary receiver (e.g., digital wideband receiver) 450 may be configured for receiving and processing signals at a particular frequency. In this regard, the secondary tuner 430 and the secondary receiver 450 may capture and process unwanted signal(s) (e.g., signal(s) S2 in FIG. 2). Thus, circuitry 400 may enable isolating the wanted and unwanted signals (particularly those that may constitute interferers).

The linear cancellation circuit 460 may then apply digital cancellation to cancel interference and/or distortion from the wanted signals, to ensure compliance with applicable requirements (e.g., the ETSI CW test) while supporting high modulation (e.g., 4096QAM). In this regard, the linear cancellation circuit 460 may apply linear cancellation, based on the unwanted signals, the CW signals, and intermodulation distortion, such as in accordance with equation 1 described above.

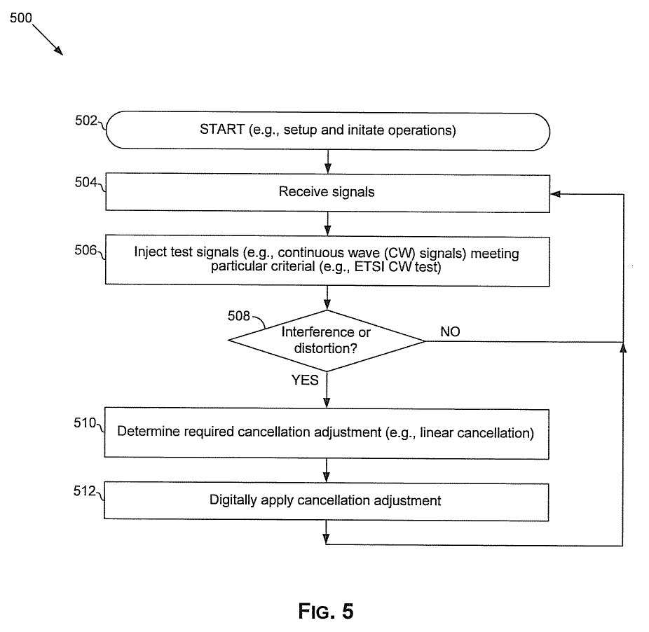

FIG. 5 illustrates a flowchart of an example process for digital interference cancellation during continuous wave (CW) tests, in accordance with the present disclosure. Shown in FIG. 5 is flow chart 500, comprising a plurality of example steps (represented as blocks 502-512), which may be performed in a suitable system (e.g., system 400 of FIG. 4) to provide digital interference cancellation during continuous wave (CW) test.

In starting step 502, the system may be setup for operation. This may include selecting and/or applying configuration parameters (including for testing purposes—e.g., for injecting test signals).

In step 504, signals that may be received. These may include wanted signals, as well as (at least in some instance) unwanted signals (e.g., interferers, such as due to transmission leakage, etc.).

In step 506, test signals (e.g., continuous wave (CW) signals that meet particular test criteria (e.g., ETSI CW test) may be injected.

In step 508, it may be determined whether interference is introduced, such as due to the injected test signals and/or the unwanted signals. This may comprise intermodulation (IM) related interference or distortion. Instances where no interference is detected, the process may loop back to step 504 to continue handling reception of signals (or alternatively, while not shown in the figure, the process may simply pause, re-start and/or end). However, in instances where interference is detected, the process may proceed to step 510.

In step 510, required cancellation adjustment (e.g., linear cancellation) may be determined (e.g., as described with respect to FIGS. 3 and 4).

In step 512, the determined cancellation adjustment may be applied digitally. The process may loop back to step 504 to continue handling reception of signals (or alternatively, while not show, simply exit the process).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
in a communication device:
receiving radio frequency (RF) signals;
injecting test signals configured for assessing performance of said communication device in accordance with at least one criterion;
processing the received RF signals;
determining when said test signals and one or more other signals different than the received RF signals, cause interference to said received RF signals, wherein said interference is unrelated to said assessing based on said at least one criterion; and
applying one or more cancellation adjustments, during processing of the RF signals, for mitigating effects of said interference.

2. The method of claim 1, wherein said one or more other signals comprise blockers and/or transmit leakage based signals.

3. The method of claim 1, wherein said test signals comprise continuous wave (CW) signals.

4. The method of claim 1, wherein said interference comprises intermodulation (IM) related interference or distortion.

5. The method of claim 1, wherein applying said one or more cancellation adjustments comprises:
applying analog-to-digital conversion to said received RF signals;
determining linear compensation based on said received RF signals, said test signals, and one or more other signals; and
digitally applying said linear compensation to said received RF signals.

6. The method of claim 1, comprising adaptively configuring said test signals based on characteristics of said received RF signals.

7. The method of claim 6, wherein said adaptive configuring comprises setting power of said test signals to meet a particular power ratio criterion relative to said received RF signals.

8. The method of claim 7, wherein said particular power ratio criterion comprises being at least 30 dBc above said received RF signals.

9. The method of claim 1, wherein said at least one criterion is based on requirements set forth by a particular organization.

10. The method of claim 9, wherein when said organization is the European Telecommunications Standards Institute (ETSI), and said requirements comprise:
said test signals comprising continuous wave (CW) signals;
said continuous wave (CW) signals being adaptively configured based on said received RF signals; and
said communication device exhibiting, in response to injecting said continuous wave (CW) signals, a sensitivity level meeting one or more particular thresholds.

11. A system, comprising:
a receiver circuit operable to:
receive radio frequency (RF) signals;
inject test signals configured for assessing performance of said communication device in accordance with at least one criterion; and
process the received RF signals; and
a cancellation circuit operable to:
determine when said test signals and one or more other signals different than the received RF signals, cause interference to said received RF signals, wherein said interference is unrelated to said assessing based on said at least one criterion; and
apply one or more cancellation adjustments, during processing of the RF signals, for mitigating effects of said interference.

12. The system of claim 11, wherein said one or more other signals comprise blockers and/or transmit leakage based signals.

13. The system of claim 11, wherein said test signals comprise continuous wave (CW) signals.

14. The system of claim 11, wherein said interference comprises intermodulation (IM) related interference or distortion.

15. The system of claim 11, wherein said cancellation circuit is operable to, when applying said one or more cancellation adjustments:
apply analog-to-digital conversion to said received RF signals;
determine linear compensation based on said received RF signals, said test signals, and one or more other signals; and
digitally apply said linear compensation to said received RF signals.

16. The system of claim 11, wherein one or both of said receiver circuit and said cancellation circuit is operable to adaptively configure said test signals based on characteristics of said received RF signals.

17. The system of claim 16, wherein said adaptive configuring comprises setting power of said test signals to meet a particular power ratio criterion relative to said received RF signals.

18. The system of claim 17, wherein said particular power ratio criterion comprises being at least 30 dBc above said received RF signals.

19. The system of claim 11, wherein said at least one criterion is based on requirements set forth by a particular organization.

20. The system of claim 19, wherein when said organization is the European Telecommunications Standards Institute (ETSI), and said requirements comprise:
said test signals comprising continuous wave (CW) signals;
said continuous wave (CW) signals being adaptively configured based on said received RF signals; and
said communication device exhibiting, in response to injecting said continuous wave (CW) signals, a sensitivity level meeting one or more particular thresholds.
